(19) United States
(12) Patent Application Publication
(10) Pub. No.: US 2005/0079256 A1
(43) Pub. Date: Apr. 14, 2005

(54) Sanitation of carcasses using chlorine dioxide solution and gas

(76) Inventor: Vincent E. Miller, Marshville, NC (US)

Correspondence Address: ROGERS TOWERS, P.A., 1301 RIVERPLACE BOULEVARD, SUITE 1500, JACKSONVILLE, FL, 32207, US

(21) Appl. No.: 10/953,964

(22) Filed: Sep. 29, 2004

Related U.S. Application Data
(60) Provisional application No. 60/506,977, filed on Sep. 29, 2003.

(51) Int. Cl. A23K 1/00

(52) U.S. Cl. 426/332; 426/521

(57) ABSTRACT

A method and apparatus for sanitizing carcasses in a conveyor system, wherein a cabinet is provided within which the carcasses are sprayed with a super-saturated solution of chlorine dioxide, are de-watered by passage through a pair of counter-rotating brushes, and are subsequently exposed to chlorine dioxide gas produced from the outgassing of the solution.

This application claims the benefit of U.S. Provisional Application Ser. No. 60/506977, filed Sep. 29, 2003.

### BACKGROUND OF THE INVENTION

The invention relates generally to the field of methods and systems for sanitizing or sterilizing articles, and more particularly to such methods and systems that are anti-microbial. Even more particularly, the invention relates to such methods and systems used in the treatment of animal carcasses, such as poultry, to retard spoilage caused by microbes, and wherein the anti-microbial treatment includes the use of chlorine dioxide.

Many different techniques for sterilization and sanitation of animal carcasses are known. For example, U.S. Pat. No. 6,348,227 to Caracciolo, Jr., teaches utilizing various gases and reduced temperature. U.S. Pat. No. 6,019,033 to Wilson et al., U.S. Pat. No. 3,657,768 to Snowden and U.S. Pat. No. 3,561,040 to Floden all show steam sterilization systems, and U.S. Pat. No. 5,651,730 to McGinnis et al. shows sterilization using hot water. U.S. Pat. No. 5,484,332 to Leech et al. shows a system where a phosphate-based solution is applied to poultry both internally and externally.

The use of chlorine in various forms as a sterilizing or sanitizing agent is known. U.S. Pat. No. 6,379,633 to Garlick uses a sterilizing fog containing ozone, chlorine or chlorous acid. U.S. Pat. No. 5,252,343 to Kross shows the use of a chlorine dioxide solution as a topical anti-bacterial agent.

The use in general of chlorine dioxide gas as a sterilizing or sanitizing agent has been long known. U.S. Pat. No. 4,681,739 to Rosenblatt et al., U.S. Pat. No. 4,362,753 to Barta, U.S. Pat. No. 4,244,978 to Barta, U.S. Pat. No. 4,021,585 to Svoboda et al., U.S. Pat. No. 3,745,026 to Hansen, and U.S. Pat. No. 2,546,568 to Taylor all show a general teaching of the use of chlorine dioxide gas in various application modes for this purpose.

One reason that chlorine-based solutions are not widely used in sterilization and sanitation systems is because of the problem of outgassing of hazardous vapors from the chlorine dioxide solution. For example, OSHA regulations permit a maximum exposure level of only 0.1 ppm. Thus, typical systems use phosphate-based solutions.

A system manufactured by the Zep Manufacturing Co. and marketed as the Zep Antimicrobial Treatment System (ZATS) utilizes a chlorine dioxide solution to sanitize chicken carcasses. The plucked birds are brought through a cabinet on a continual conveyor system. Within the cabinet are three exposure zones. In each zone the carcasses are exposed to a chlorine dioxide solution of increasing antimicrobial efficacy. In zone three, the final exposure zone, a chlorine dioxide solution is sprayed onto the carcasses. The run-off solution is captured and delivered to zone two, where it is sprayed onto the carcasses prior to their entering zone three. The run-off solution is again captured and finally delivered to zone one, the initial exposure zone, where it is sprayed onto the carcasses primarily to remove physical contaminants prior to their entering zone two. To avoid the hazardous outgassing problems, the chlorine dioxide solution is produced and stored within a holding tank where outgassing is allowed to occur, such that a solution concentration of approximately only 3 ppm is utilized, which significantly reduces the effectiveness of the process.

It is an object of this invention to provide a method and a system for the sanitation of carcasses that utilizes both a chlorine dioxide solution and chlorine dioxide gas resulting from outgassing of the chlorine dioxide solution, wherein the concentration of the chlorine dioxide solution can be maximized to greatly increase the effectiveness of the process. It is a further object of this invention to utilize a combination of spray nozzles to deliver super-saturated chlorine dioxide solution within a wet zone to carcasses passing through a cabinet on a continuous conveyor system, rotating brushes to strip the liquid from the carcasses, to open the pores or follicles of the carcasses by physical contact and to create movement of the chlorine dioxide gas within a dry zone of the cabinet, and a combination of exhaust means and air diffuser members to insure negative pressure within the cabinet such that no gas escapes through the entrance or exit openings.

### SUMMARY OF THE INVENTION

The invention is in general a method and an apparatus or system for sanitizing objects, and in particular meat carcasses such as poultry, by eradicating and preventing growth of bacterial microbes (e.g., salmonella, e. coli) on exposed surfaces in order to retard spoilage. The method and apparatus is a component of a larger conveyor-type processing system such that the sanitation occurs with the objects to be sanitized moving through the invention apparatus in a continuous manner, typically on a moving conveyor having spaced hooks to receive the carcasses.

The apparatus comprises a cabinet adapted to enclose a conveyor line such that carcasses are brought into the cabinet through an entrance opening and pass from the cabinet through an exit opening in a continuous manner. Air diffusers or blowers direct air in the cabinet adjacent both the entrance and exit opening to create, in combination with an exhaust system, a slight negative pressure within the cabinet such that all air and gasses within the cabinet are vented through the exhaust system rather than through either of the openings. A pair of chemical spray headers are disposed adjacent the entrance opening such that sanitizing solution is applied to the carcasses from both sides, and in the case of poultry carcasses is also directed into the cropper hole to contact the interior exposed surfaces, as they pass through the wet zone of the cabinet. The solution is a super-saturated solution comprising approximately at least 35 ppm of chlorine dioxide and preferably about 80 to 85 ppm of chlorine dioxide. Excess solution is retained within the cabinet by solution retainer means, such as a sump or reservoir, generally longitudinally extensive to the cabinet, and subsequently treated or disposed of.

The carcasses next pass between dewatering means to remove excess solution from the carcasses, such as a pair of rotary brushes oriented with vertical axes of rotation with the rotary brushes rotating in opposing directions. The brushes rotate such that the direction of rotation on the side contacting the carcass is back toward the entrance opening. The rotation speed is chosen such that liquid will be slung from the carcasses and the brushes only in the direction of the entrance opening, thereby defining a wet zone within the cabinet. The carcasses then pass into a dry zone within the cabinet of greater length than the wet zone, where the carcasses are exposed to outgassed chlorine dioxide gas from the chlorine dioxide solution. The rotation of the brushes creates an upwardly progressing vortex that maximizes exposure of the carcasses to the chlorine dioxide gas prior to its being exhausted from the cabinet.

The carcasses are sanitized in multiple ways. In the wet zone, the solution of super-saturated chlorine dioxide kills microbes by contact and removes physical contaminants by liquid flow. Because the solution is super-saturated, outgassing of chlorine dioxide gas begins immediately. The brushes dewater the carcasses, disrupt the boundary layer and open the pores or follicles on the exterior of the carcasses. The chlorine gas outgassed from the solution and circulated by the brush vortex, air diffusers and exhaust system continues to sanitize the carcasses by killing any remaining microbes during transition through the dry zone.

### BRIEF DESCRIPTION OF THE DRAWINGS

FIG. 1 is an exposed view of the invention.

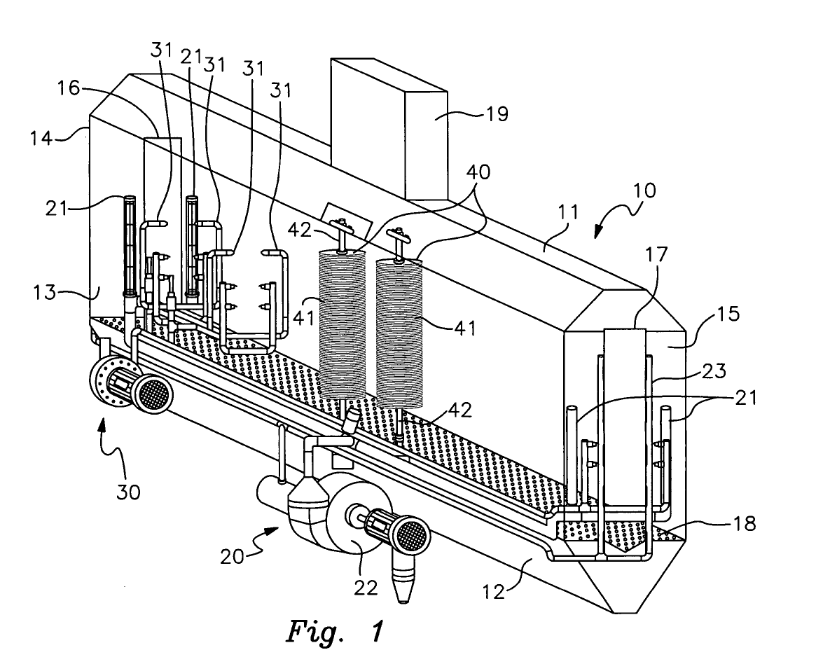

FIG. 2 is an exposed view of the invention similar to FIG. 1, showing the flow pattern of outgassed chlorine dioxide gas within the cabinet.

FIG. 3 is a simplified exposed view of the invention showing the poultry carcass conveyor line passing through the cabinet.

### DETAILED DESCRIPTION OF THE INVENTION

With reference to the drawings, the invention will now be described in detail with regard for the best mode and preferred embodiment.

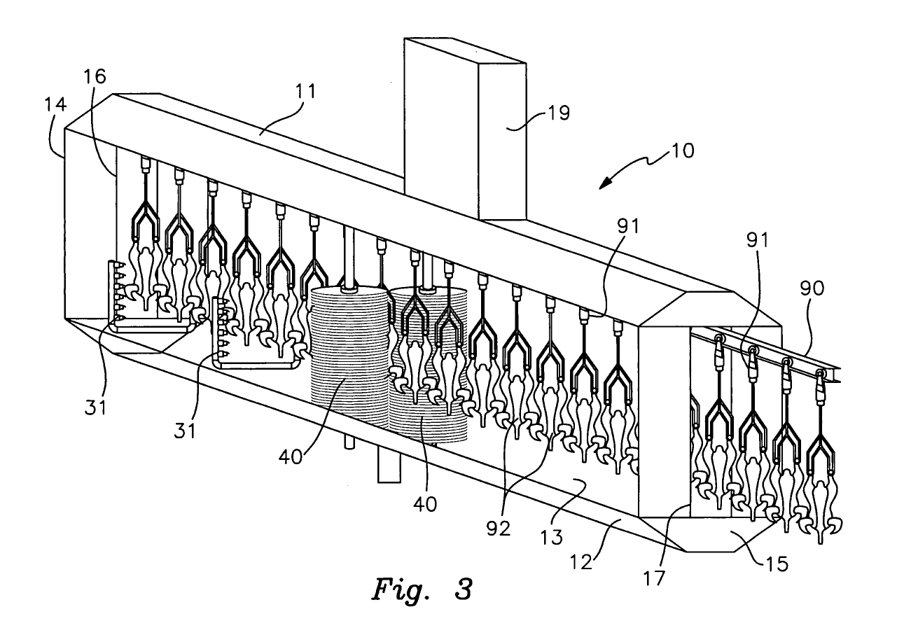

The cabinet 10 comprises a top 11 and bottom 12, both preferably tapered, a pair of longitudinal side walls 13, a front end 14 and a rear end 15. The cabinet 10 is provided with an entrance opening 16 in the front end 14 and an exit opening 17 in the rear end 15. An apertured floor 18 resides a short distance above the bottom 12, with the bottom 12 defining or retaining a sump or pan to receive liquid. An exhaust means 19 of known type is mounted onto the cabinet top 11 at a generally centralized location and draws air and gases from the interior of the cabinet 10 for treatment and disposal. As seen in FIG. 3, the cabinet 10 is adapted to enclose or surround a conveyor line 90 having a plurality of hanger members 91 on which are suspended a plurality of carcasses 92, wherein the conveyor line 90 continuously brings the carcasses 92 into the entrance opening 16, through the cabinet 10 and out the exit opening 17. Such conveyor lines 90 are well known in the industry. The cabinet 10 and other components may be formed of any material suitable for use in the chemical environment to be described, such as stainless steel, plastic, fiberglass or the like. The cabinet 10 may typically be from two to ten feet in width, from four to fifty feet in length, and from two to twelve feet in height, but these dimensional ranges are representative rather than absolute, with the size of the cabinet 10 being dictated by line speed, the level of pathogens expected to be encountered, and other factors.

The entrance opening 16 and exit opening 17 are preferably unencumbered by physical curtains, brushes or the like, although such may be provided to further insure that negative pressure is maintained within the cabinet 10. Inwardly directed air diffuser or blower members 21 that are part of an air induction system 20 are located at both the entrance opening 16 and the exit opening 17. The air diffuser members 21 are preferably adjustable as to air flow volume and direction and are supplied with air by air blower means 22. The amount of air influx through the air diffusers 21 is preferably at least 75 percent of the total exhaust volume removed from the cabinet 10 by exhaust system means 19, with the remainder of the exhaust volume being made up of outgassed chlorine dioxide and ambient air drawn primarily through the entrance opening 16 and exit opening 17. In this manner the cabinet 10 is maintained at a slight negative pressure such that no air flow occurs out of the cabinet 10 through either the entrance opening 16 or the exit opening 17. For added efficiency to insure that no gas escapes from the cabinet 10, suction members 23 may be disposed adjacent or external to the entrance opening 16 and the exit opening 17, with any gas captured by the suction members 23 being routed back to the air blower 22 and into the cabinet through the air diffusers 21. Preferably, the volume of air flow from the air diffusers 21 located at the exit opening 17 is slightly greater by about 10 percent than the air flow from the air diffusers 21 located at the entrance opening 16.

Inboard to the entrance opening 16 are solution applying means, such as a pair of spray headers 31 supplied with liquid sanitizing solution from the solution induction system 30. The spray headers 31 within wet zone 81 direct solution onto the exterior of the carcass 92 as well as into the open cropper hole of the poultry carcass 92. The solution is sprayed with sufficient force and in sufficient volume to completely coat the carcasses 92 and to flush particulates and other contaminants from the surface of the carcass 92. The excess solution flows through the apertured floor 18 into solution retainer means, such as a sump or reservoir, and is removed for treatment or delivered to an up-line apparatus for pre-sanitizing the carcasses 92 prior to entry into the cabinet 10. The apertured floor 18 and sump extend into the dry zone 82 both to capture any remaining solution dripping from the carcasses 92 after passage through the brushes 40, as well as to provide an additional source of outgassing to deliver chlorine dioxide gas into the dry zone 82. Chlorine dioxide gas outgassed from the applied chlorine dioxide solution is retained within the cabinet 10 for use in the dry zone 82.

The sanitizing solution is a super-saturated solution produced on-site using known technology and comprises at least 35 ppm of chlorine dioxide and preferably about 80 to 85 ppm of chlorine dioxide in water to create a super-saturated solution for sanitizing the carcasses 92. The solution is generated as needed and used within a short time of production rather than being stored for any significant period of time, such that the concentration of chlorine dioxide in the solution does not diminish from outgassing during storage, but rather outgassing occurs within the cabinet 10 in significant amount immediately upon spraying and application to the carcasses in the wet zone 81.

Dewatering means, preferably comprising a pair of oppositely rotating rotary brushes 40 having generally horizontally oriented bristles 41 disposed on generally vertical spindles 42 are located down-line from the spray headers 31, with one brush 40 located to either side of the conveyor line 90 and carcasses 92. The brushes 40 rotate such that the bristles 41 contacting the carcasses 92 are traveling in the direction toward the entrance opening 16. In this manner excess solution is removed from the carcasses 92 and flung back toward the spray headers 31. The rotation speed is chosen such that virtually all of the excess solution is directed into the wet zone 81 before the brushes 40 and virtually none of the solution is directed into the dry zone 82 behind the brushes 40. The bristles 41 are preferably densely packed, somewhat flexible and composed of a synthetic material resistant to degradation from chlorine dioxide. The brushes 40 are separated such that preferably only the last inch of the bristles 41 contacts the carcass 92. The hanger members 91 of the conveyor line 90 allow some rotation of the carcass 92 as it is struck by the bristles 41, insuring that the entire exterior surface of the carcass 92 is contacted. The brushes 40 de-water the carcasses 92 by removing excess solution in order to reduce outgassing below hazardous levels when the carcasses exit the cabinet 10, and also act as pore opening means to break the surface layer on the carcasses 92 to open closed pores or follicles such that the interior of the pores or follicles will be exposed to the chlorine dioxide gas in the dry zone 82.

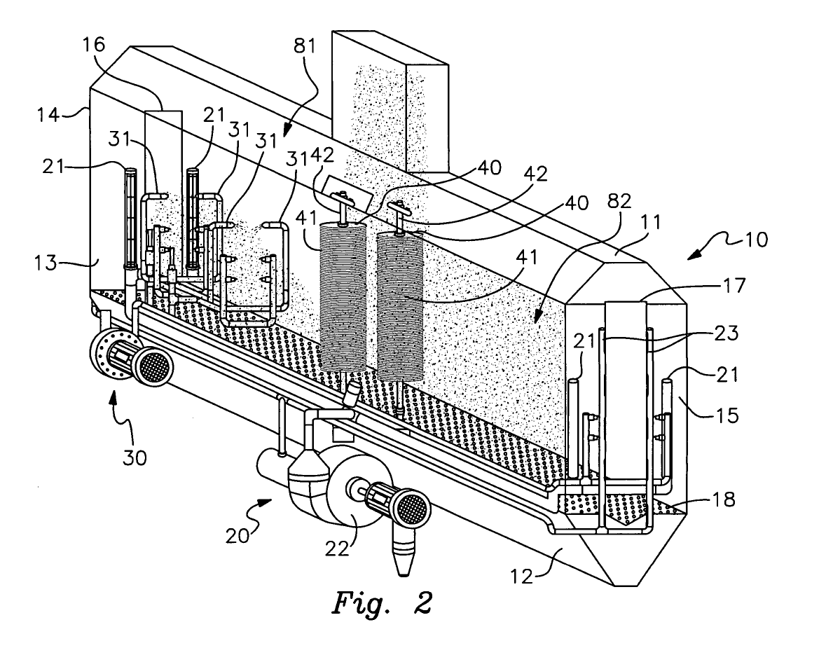

The rotating brushes 40 also act to control, direct and accelerate gas flow within the dry zone 82. There is no fog, mist or suspended droplets of sanitizing solution within the dry zone 82. The combination of air flow from the air diffusers 21 located at the entrance opening 16, the air diffusers located at the exit opening 17, the rotation of the brushes 40, and the exhaust system 19 create an upwardly moving vortex within the dry zone 82. This vortex draws chlorine dioxide gas that has outgassed from the solution within the wet zone 81 and from the solution resident in the sump, and oncentrates and accelerates it within the dry zone 82. The concentration of chlorine dioxide gas in the dry zone 82 is approximately 20 ppm and preferably the gas circulation created by the vortex is at least three feet per second relative to the carcasses 92 in the dry zone. As shown in FIG. 2, the air diffusers 21 at the entrance opening 16 direct air and chlorine dioxide gas down toward the outer sides of the brushes 40. The rotation of the brushes 40 pulls the chlorine dioxide gas into the dry zone 82, a small gap of approximately six inches being provided between the interior of the side walls 13 and the ends of the bristles 41.

As a representative example, for a single file conveyor line 90 moving at a rate of 140 carcasses 92 per minute separated at six inch centers, a suitable cabinet 10 is approximately 14 feet in length, six feet in height and 40 inches wide. Super-saturated solution at approximately 85 ppm chlorine dioxide is delivered onto the carcasses 92 through the spray headers 31 at about 42 gallons per minute. The carcasses 92 reside in the wet zone 81 approximately six seconds and in the dry zone 82 approximately 10 seconds, the dry zone 82 being of greater length than the wet zone 81. The brushes 40 are approximately one foot in diameter and 40 inches in height, with bristles 41 of about 1/16 inch in diameter. Rotation speed of the brushes 40 is approximately 25 rpm. The exhaust flow is about 1150 cfm and the inflow from the air diffusers 21 is about 1000 cfm.

The system is provided with a number of switches, control valves and safety devices that are coordinated by a PLC, such being well known in the industry. The PLC determines that the exhaust system 19 is properly functioning, that sufficient water flow into the system is occurring, that the dissolved chlorine dioxide within the solution and the chlorine dioxide gas within the dry zone 82 are within the acceptable and necessary limits, and that there is no chlorine dioxide escaping from the cabinet 10, among other tasks.

The system and method may further comprise a preliminary treatment cabinet upline of the treatment cabinet 10, wherein the carcasses 92 may be exposed to recycled chlorine dioxide solution taken from cabinet 10 and/or to recycled chlorine dioxide gas taken from cabinet 10. Both the gas and the solution will be of reduced concentration, typically by about 50 percent, since a significant portion of the chlorine dioxide gas will have outgassed from the chlorine dioxide solution when introduced into the wet zone 81 of cabinet 10, and since the chlorine dioxide gas taken from the dry zone 82 of cabinet 10 will have been diluted with diffused or ambient air as required to maintain a negative pressure within cabinet 10. This preliminary cabinet may also be supplied with brushes 40 to increase the efficacy of the treatment, although experimentally this has not been found to be required.

It is contemplated that equivalents and substitutions to certain elements set forth above may be obvious to those skilled in the art, and therefore the true scope and definition of the invention is to be as set forth in the following claims. The use of the term preferred or variations thereof is not to be taken to imply or require that any characteristic, value, element or the like so labeled is limited solely to the preferred depiction, but rather that variations lying within the scope of the claim language remains inclusive.

1. A method of sanitizing carcasses comprising the steps of:
applying a chlorine dioxide solution to the carcasses;
retaining chlorine dioxide gas outgassed from said chlorine dioxide solution applied to said carcasses; and
subsequently exposing the carcasses to said outgassed chlorine dioxide gas.

2. The method of claim 1, wherein said chlorine dioxide solution is a super-saturated solution.

3. The method of claim 1, wherein said chlorine dioxide solution has a chlorine dioxide concentration of at least approximately 35 ppm.

4. The method of claim 1, wherein said chlorine dioxide solution has a chlorine dioxide concentration of at least approximately 80 ppm.

5. The method of claim 1, wherein the chlorine dioxide gas has a chlorine dioxide concentration of approximately 20 ppm.

6. The method of claim 1, further comprising the step of dewatering the carcasses to remove excess chlorine dioxide solution after applying said chlorine dioxide solution to said carcasses and prior to exposing said carcasses to said chlorine dioxide gas.

7. The method of claim 6, wherein said step of dewatering is accomplished by passing said carcasses through rotating brushes.

8. The method of claim 1, further comprising the step of opening pores in said carcasses prior to exposing said carcasses to said chlorine dioxide gas.

9. The method of claim 8, wherein said step of opening pores is accomplished by passing said carcasses through rotating brushes.

10. The method of claim 1, further comprising the step of circulating said chlorine dioxide gas during said step of exposing said carcasses to said chlorine dioxide gas.

11. The method of claim 11, wherein said step of circulating chlorine dioxide gas is accomplished by providing rotating brushes, air diffusers and an exhaust system.

12. The method of claim 6, further comprising the step of opening pores in said carcasses prior to exposing said carcasses to said chlorine dioxide gas.

13. The method of claim 12, wherein said step of dewatering and said step of opening pores is accomplished by passing said carcasses through rotating brushes.

14. The method of claim 12, further comprising the step of circulating said chlorine dioxide gas during said step of exposing said carcasses to said chlorine dioxide gas.

15. An apparatus for sanitizing carcasses by applying a chlorine dioxide solution to said carcasses and subsequently exposing said carcasses to chlorine dioxide gas, said apparatus comprising:
a cabinet having an entrance opening allowing passage of carcasses into said cabinet and an exit opening allowing passage of said carcasses out of said cabinet, said cabinet having a wet zone and a dry zone;
solution applying means within said wet zone of said cabinet, said solution applying means delivering a chlorine dioxide solution onto said carcasses passing through said wet zone;
dewatering means to remove excess chlorine dioxide solution from said carcasses passing from said wet zone into said dry zone;
means to retain and circulate within said dry zone chlorine dioxide gas outgassed from said chlorine dioxide solution applied to said carcasses within said wet zone, whereby said carcasses are exposed within said dry zone to said outgassed chlorine dioxide gas prior to passing through said exit opening.

16. The apparatus of claim 15, wherein said solution applying means comprises spray headers.

17. The apparatus of claim 15, wherein said dewatering means comprises rotating brushes.

18. The apparatus of claim 16, wherein said dewatering means comprises rotating brushes.

19. The apparatus of claim 15, wherein said retaining and circulating means comprises air diffusers disposed adjacent said entrance opening and said exit opening.

20. The apparatus of claim 16, wherein said retaining and circulating means comprises air diffusers disposed adjacent said entrance opening and said exit opening.

21. The apparatus of claim 17, wherein said retaining and circulating means comprises air diffusers disposed adjacent said entrance opening and said exit opening.

22. The apparatus of claim 18, wherein said retaining and circulating means comprises air diffusers disposed adjacent said entrance opening and said exit opening.

23. The apparatus of claim 17, wherein said rotating brushes are paired such that said carcasses pass between said rotating brushes, and further wherein said rotating brushes rotate in opposite directions such that chlorine dioxide solution removed from said carcasses is deposited into said wet zone.

24. The apparatus of claim 15, further comprising conveyor means to convey said carcasses through said cabinet is a continuous manner.

25. The apparatus of claim 15, further comprising exhaust means to remove said chlorine dioxide gas from said cabinet.

26. The apparatus of claim 25, wherein negative pressure is maintained within said cabinet such that said chlorine dioxide gas exits said cabinet only through said exhaust means.

27. The apparatus of claim 15, further comprising means to pores on said carcasses.

28. The apparatus of claim 27, wherein said pore opening means comprises rotating brushes.

29. The apparatus of claim 27, wherein said dewatering means and said pore opening means comprises rotating brushes.

30. The apparatus of claim 15, wherein said retaining and circulating means comprises rotating brushes, air diffusers disposed adjacent said entrance opening and said exit opening, and exhaust means.
